(19) United States
(12) Patent Application Publication
(10) Pub. No.: US 2026/0147527 A1
(43) Pub. Date: May 28, 2026

(54) METHOD AND DEVICE FOR MANAGING CODEC CONFIGURATION OF BROADCAST AUDIO STREAM

(71) Applicant: SAMSUNG ELECTRONICS CO., LTD., Suwon-si (KR)

(72) Inventors: Pramod Reddy SERIKAR, Bengalore (IN); Veerabhadrappa CHILAKANTI, Bengalore (IN); Lakshay GUPTA, Bengalore (IN); Gurumani Lakshmi Praneeth JUTURU, Bengalore (IN); Srihari SRIRAM, Bengalore (IN)

(73) Assignee: SAMSUNG ELECTRONICS CO., LTD., Suwon-si (KR)

(21) Appl. No.: 19/453,444

(22) Filed: Jan. 20, 2026

Related U.S. Application Data
(63) Continuation of application No. PCT/KR2024/019093, filed on Nov. 28, 2024.

(30) Foreign Application Priority Data
Nov. 28, 2023 (IN) 202341080738

(51) Int. Cl. G06F 3/16

(52) U.S. Cl. CPC G06F 3/162; G06F 3/165

(57) ABSTRACT

Methods for managing dynamic codec configuration of audio stream by transmitter device are provided. The method includes detecting event to change first codec configuration of the audio stream while the transmitter device is broadcasting audio stream. Further, the method includes determining a second codec configuration and a timing information for the ongoing broadcast audio stream based on the detected event. The second codec configuration is different than the first codec configuration. The timing information indicates a time at which the second codec configuration is to be used by the at least one receiver device. Further, the method includes sending a control packet to the receiver device to modify the first codec configuration of the audio stream at the at least one receiver device while audio stream is broadcasted by the transmitter device. The control packet includes second codec configuration and timing information.

### CROSS-REFERENCE TO RELATED APPLICATIONS

This application is a Continuation Application of International Application PCT/KR2024/019093 filed on Nov. 28, 2024, which claims benefit of Indian Patent Application number 202341080738, filed on Nov. 28, 2023, at the Office of the Controller General of Patents, Designs, and Trademarks in India, the disclosures of which are incorporated herein in their entireties by reference.

### BACKGROUND

### 1. Field

The disclosure relates to the field of multimedia stream broadcast system, and particularly relates to a method and a device for managing dynamic codec configuration of an audio stream.

### 2. Description of Related Art

In essence, a broadcast audio permits the transmission of one or multiple audio streams to innumerable electronic devices such as smartphones, tablets, headsets, and similar devices. The broadcast technology enables audio sharing applications to disseminate audio streams from phones or tablets to multiple users' headphones within the same vicinity. Additionally, broadcast transmitters like TV facilitate the transmission of diverse audio content such as standard definition (SD), high definition (HD), ultra-high definition (UHD), gaming, and so on. Although the quality requirements for different content types may differ, the current limitation of broadcast transmitters is that they transmit audio content with fixed codec configuration. Once the broadcast transmitter is in a streaming state, there is no provision to update the codec configuration of any Broadcast Isochronous Stream (BIS) dynamically.

The Bluetooth specifications offer a modest unreserved retransmission capability that enhances the audio quality during a broadcast setting, regardless of the audio perception of the headset wearer. Once the broadcasting transmitter is streaming, however, there is no allowance for the dynamic adjustment of codec configuration for any BIS.

FIG. 1 represents a scenario (S100) that exemplifies the use of a transmitter device (100)—such as an audio transmitter—to broadcast audio content to an unlimited number of nearby Bluetooth audio receivers (e.g., receiver devices) (200) through an assistant device (300), as per prior art.

The broadcast audio feature allows the audio transmitter device (100) to effortlessly transmit audio (such as broadcast audio) to an unlimited number of nearby Bluetooth audio receivers. The transmitter device (100) (e.g. transmitter) initiates an broadcast that includes advertisements (102), left stereo information (104), and a right stereo information (106). These ads provide an assistant device (e.g. assistants device) (300) with essential information about the broadcast, including name, content, codec configuration, and one or more audio streams (such as left and right stereo audio streams).

The assistant device (e.g. assistant device) (300) scans for advertisements and offers a user interface (UI) that enables users to join a particular broadcast. The UI is similar to the one commonly used to connect to Wi-Fi networks in public spaces.

After selecting a broadcast, the assistant device provides the necessary information to the receiver (e.g. headphone, earbud, hearing aid, etc.) that is required to join the broadcast.

FIG. 2 represents a scenario (S200) in which the transmitter device (100) seamlessly transmits audio content to an unlimited number of nearby Bluetooth audio receivers through the assistant device (300), upon detecting a context switching, in accordance with the prior art. In this scenario (S200), consider John (206a), Eva (206b), and Ivan (206c) find themselves in a room enveloped by a Bluetooth low energy (LE) audio stream transmitted by a smart TV with two BIS channels, one for each stereo channel. Equipped with LE audio headsets, they synchronize with the transmitter device (100)'s audio to immerse themselves in the game they are playing. However, at S202, when a cut-scene interrupts the game, the audio context switches from gaming to media, requiring different configuration settings for optimal sound quality. If the transmitter device (100) continues to broadcast audio with low latency, the audio quality will suffer, causing an unpleasant user experience. To ensure an optimal experience, the transmitter device (100) must restart the broadcast stream with updated configuration settings, causing a glitch in the user's headset. Once the cut-scene ends, at S204, the transmitter device (100) must restart the broadcast stream with the original configuration used during gaming, resulting in another glitch in the user's headset.

FIG. 3 depicts a scenario (S300) in which the transmitter device (100) broadcasts the audio content to an infinite number of adjacent Bluetooth audio receivers upon detecting bandwidth fluctuations and diverse RF conditions emanating from a Wireless Fidelity (Wi-Fi) router (310) in accordance with the prior art. In this scenario (S300), John (206a), Eva (206b) and Ivan (206c) are in a room, where they are surrounded by TV broadcasting audio stream over the Bluetooth low energy (BLE). The smart TV is acting as the transmitter device (100) broadcasting the audio content with stereo channels and two BIS's are broadcasted such as left channel BIS and right channel BIS. All of them are wearing LE audio headsets and are synchronized to the transmitter device (100)'s audio and able to listen to broadcasted audio content. At S302, they all decide to stream a movie over the internet but due to fluctuations in bandwidth and varying RF conditions, they experience choppiness, leading to a subpar user experience.

It is desired to address the above-mentioned disadvantages or other short comings or at least provide a useful alternative.

### SUMMARY

Additional aspects will be set forth in part in the description which follows and, in part, will be apparent from the description, or may be learned by practice of the presented embodiments. In an example embodiment, a method for managing dynamic codec configuration of an audio stream is disclosed. The method includes broadcasting, by a transmitter device, the audio stream in a first codec configuration to at least one receiver device of a plurality of receiver devices. Further, the method includes detecting, by the transmitter device, an event to change the first codec configuration of the audio stream when the transmitter device is broadcasting the audio stream. Further, the method includes determining based on the detected event, by the transmitter device, a second codec configuration and a timing information for the ongoing broadcast audio stream. The second codec configuration is different than the first codec configuration. The timing information indicates a time at which the second codec configuration is to be used by the at least one receiver device. Further, the method includes sending when the audio stream is broadcasted, by the transmitter device, a control packet to the at least one receiver device to modify the first codec configuration of the audio stream at the at least one receiver device. The control packet includes the second codec configuration and the timing information.

In an example embodiment, the method includes sending, by the transmitter device, a broadcast isochronous group (BIG) control packet to the at least one receiver device based on the second codec configuration. The BIG control packet includes an operation code (opcode) field identifying a type of control packet, and an instant field indicating the BIG event at which new codec configuration is applied and updated codec configuration data.

In an example embodiment, the event includes a change in at least one of a content format indicating a quality of the ongoing broadcast audio stream, an audio context of the ongoing broadcast audio stream, and a radio frequency channel assessment indicating a congestion level of the ongoing broadcast audio stream.

In an example embodiment, the first codec configuration is dynamically modified to the second codec configuration of the audio stream at the at least one receiver device without restarting broadcast of the audio stream from the transmitter device.

In an example embodiment, the audio stream is a low-energy audio broadcast isochronous stream.

In an example embodiment, broadcasting, by the transmitter device, the audio stream in the first codec configuration to the at least one receiver device of the plurality of receiver devices includes scanning, by an assistant device, the transmitter device that is near to the assistant device to enable a user to select the transmitter device, sending, by the transmitter device, advertisement information and audio streams to the assistant device once the user selects the transmitter device, where the advertisement information includes a name, content, the first codec configuration and audio streams including left stereo audio streams and right stereo audio streams, sending, by the assistant device, the advertisement information and the audio streams to the at least one receiver device, and synchronization, by the at least one receiver device, the audio streams at the transmitter device with the at least one receiver device based on the advertisement information and the audio streams from the transmitter device to receive the audio stream in the first codec configuration.

In an example embodiment, a method for managing dynamic codec configuration of an audio stream is disclosed. The method includes receiving, by at least one receiver device of a plurality of receiver devices, the audio stream in a first codec configuration broadcasted by a transmitter device. Further, the method includes receiving, by the at least one receiver device, a control packet from the transmitter device to modify the first codec configuration of the audio stream. The control packet includes a second codec configuration and timing information. The second codec configuration is different than the first codec configuration. The timing information of the control packet indicates a time at which the second codec configuration is to be used. Further, the method includes dynamically modifying, by the at least one receiver device, the first codec configuration to the second codec configuration of the audio stream based on the timing information received in the control packet while receiving the audio stream broadcasted by the transmitter device.

In an example embodiment, the method includes receiving, by the at least one receiver device, a BIG control packet from the transmitter device based on the second codec configuration. Further, the method includes updating, by the at least one receiver device, a skip parameter and a synchronization timeout parameter subsequent to receiving the BIG control packet from the transmitter device. Further, the method includes initiating, by the at least one receiver device, a reconfiguration of a periodic advertisement (PA) synchronization procedure parameters once the first codec configuration is modified to the second codec configuration. The PA synchronization is performed based on the updated skip parameter and the updated synchronization timeout parameter.

In an example embodiment, the method further includes activating, by the at least one receiver device, a host controller interface (HCI) command after initiation of the reconfiguration of the PA synchronization. Further, the method includes broadcasting, by the at least one receiver device, a notification to the assistant device. The notification represents the at least one receiver device is synchronized to the second codec configuration. Further, the method includes reconfiguring, by the at least one receiver device, an isochronous data path. Further, the method includes receiving, by the at least one receiver device, the BIG control packet with respect to the second codec configuration from the transmitter device.

In an example embodiment, a system for managing dynamic codec configuration of an audio stream is disclosed. The system includes an assistant device connected to a transmitter device and a receiver device. The transmitter device includes a memory storing information about a plurality of receiver devices, a processor, and a codec configuration controller communicatively coupled to the memory and the processor. The codec configuration controller is configured to broadcast the audio stream in a first codec configuration to at least one receiver device of the plurality of receiver devices. Further, the codec configuration controller is configured to detect an event to change the first codec configuration of the audio stream while the transmitter device is broadcasting the audio stream. Further, the codec configuration controller is configured to determine a second codec configuration and a timing information for the ongoing broadcast audio stream based on the detected event. The second codec configuration is different than the first codec configuration, and the timing information indicates a time at which the second codec configuration is to be used by the at least one receiver device. Further, the codec configuration controller is configured to send a control packet to the at least one receiver device to modify the first codec configuration of the audio stream at the at least one receiver while the audio stream is broadcasted by the transmitter device. The control packet includes the second codec configuration and the timing information.

In an example embodiment, the at least one receiver device includes a codec configuration controller communicatively coupled to a memory and a processor. The codec configuration controller is configured to receive the audio stream in a first codec configuration broadcasted by a transmitter device. Further, the codec configuration controller is configured to receive a control packet from the transmitter device to modify the first codec configuration of the audio stream. The control packet includes a second codec configuration and timing information. The second codec configuration is different than the first codec configuration. The timing information of the control packet indicates a time at which the second codec configuration is to be used. Further, the codec configuration controller is configured to dynamically modify the first codec configuration to the second codec configuration of the audio stream based on the timing information received in the control packet while receiving the audio stream broadcasted by the transmitter device.

These and other aspects of the example embodiments herein will be better appreciated and understood when considered in conjunction with the following description and the accompanying drawings. It should be understood, however, that the following descriptions, while indicating example embodiments and numerous specific details thereof, are given by way of illustration and not of limitation. Many changes and modifications may be made within the scope of the example embodiments herein without departing from the scope thereof, and the example embodiments herein include all such modifications.

### BRIEF DESCRIPTION OF DRAWINGS

The disclosure is illustrated in the accompanying drawings, throughout which like reference letters indicate corresponding parts in the various figures. The embodiments herein will be better understood from the following description with reference to the drawings, in which:

FIG. 1 represents a scenario that exemplifies the use of a transmitter device—such as an audio transmitter—to broadcast audio content to an unlimited number of nearby Bluetooth audio receivers (e.g., receiver devices or the like) through an assistant device, as per prior art.

FIG. 2 represents a scenario in which the transmitter device seamlessly transmits audio content to an unlimited number of nearby Bluetooth audio receivers through the assistant device, upon detecting a context switching, in accordance with the prior art;

FIG. 3 depicts a scenario in which the transmitter device broadcasts audio content to an infinite number of adjacent Bluetooth audio receivers upon detecting bandwidth fluctuations and diverse RF conditions emanating from a Wi-Fi router in accordance with the prior art;

FIG. 4 illustrates an overview of a system for managing dynamic codec configuration of an audio stream, according to various embodiments as disclosed herein;

FIG. 5 is a block diagram illustrating various hardware components of the transmitter device, according to various embodiments as disclosed herein;

FIG. 6 is a block diagram illustrating various hardware components of the receiver device, according to various embodiments as disclosed herein;

FIG. 7 is a block diagram illustrating an internal hardware component of the transmitter device, according to various embodiments as disclosed herein;

FIG. 8 is a block diagram illustrating an internal hardware components of the receiver device, according to various embodiments as disclosed herein;

FIG. 9 is a flow chart illustrating a method implemented by the transmitter device for managing the dynamic codec configuration of the audio stream, according to various embodiments as disclosed herein;

FIG. 10 is a flow chart illustrating a method implemented by the receiver device for managing the dynamic codec configuration of the audio stream, according to various embodiments as disclosed herein;

FIG. 11 is an example flow chart illustrating a method, implemented by the transmitter device, for managing the dynamic codec configuration of the audio stream, according to various embodiments as disclosed herein;

FIG. 12 is an example flow chart illustrating a method, implemented by the assistant device, for managing the dynamic codec configuration of the audio stream, according to various embodiments as disclosed herein;

FIG. 13 is an example flow chart illustrating a method, implemented by the receiver device, for managing the dynamic codec configuration of the audio stream, according to various embodiments as disclosed herein;

FIG. 14 depicts a sequence diagram in which the transmitter device initiates a request for reconfiguration to the receiver device and the request includes the latest codec configuration and real-time event updates, accordingly to various embodiments as disclosed herein;

FIG. 15 illustrates a generic packet format of Broadcast isochronous protocol data unit (PDU) and format of a payload field in a BIG control PDU, according to various embodiments as disclosed herein;

FIG. 16 illustrates a codec configuration structure, according to various embodiments as disclosed herein;

FIG. 17 illustrates example time reference pertaining to the BIG_CODEC_CONFIG_UPDATE_IND, according to various embodiments as disclosed herein;

FIG. 18 is an example illustration for BIGInfo describing BIG streams, while receiving broadcast isochronous streams, according to various embodiments as disclosed herein;

FIG. 19 is illustrates example time reference of procedure to optimize PA scan using a skip parameter, according to various embodiments as disclosed herein;

FIG. 20 is an example illustration in which transmitter device state machine changes are explained, according to various embodiments as disclosed herein;

FIG. 21 is an example scenario in which the transmitter device to broadcast the audio content to the unlimited number of nearby Bluetooth audio receivers through the assistant device, when the transmitter device detects the context switching, according to various embodiments as disclosed herein;

FIG. 22 is an example scenario in which the transmitter device to broadcast the audio content to the unlimited number of nearby Bluetooth audio receivers when the transmitter device detects bandwidth fluctuations and varying RF conditions from the Wi-Fi router, according to various embodiments as disclosed herein;

FIG. 23 illustrates example sequence diagram in which the system manages the dynamic codec configuration of the audio stream, according to various embodiments as disclosed herein;

FIG. 24 is an example sequence diagram in which the transmitter device to broadcast the audio content to the unlimited number of nearby Bluetooth audio receivers through the assistant device when the transmitter device detects the context switching, according to various embodiments as disclosed herein; and

FIG. 25 is an example sequence diagram in which the transmitter device to broadcast the audio content to the unlimited number of nearby Bluetooth audio receivers when the transmitter device detects bandwidth fluctuations and varying RF conditions from the Wi-Fi router, according to various embodiments as disclosed herein.

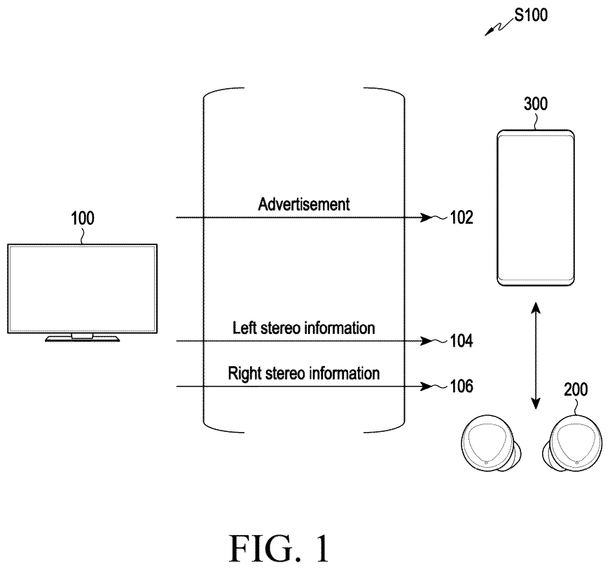

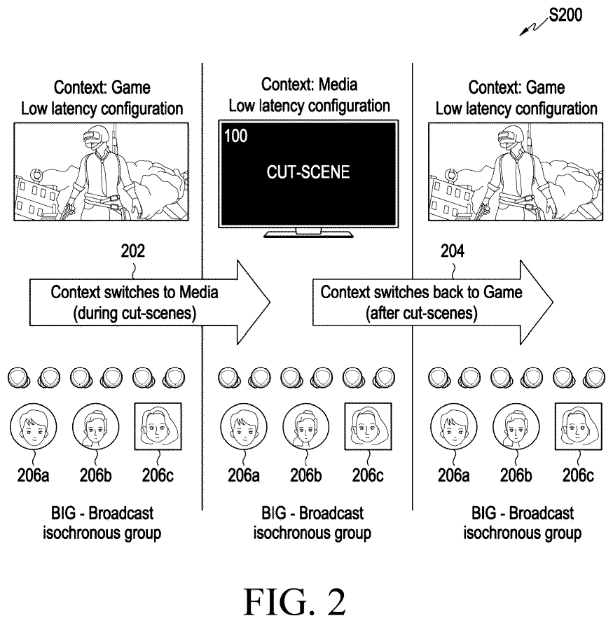

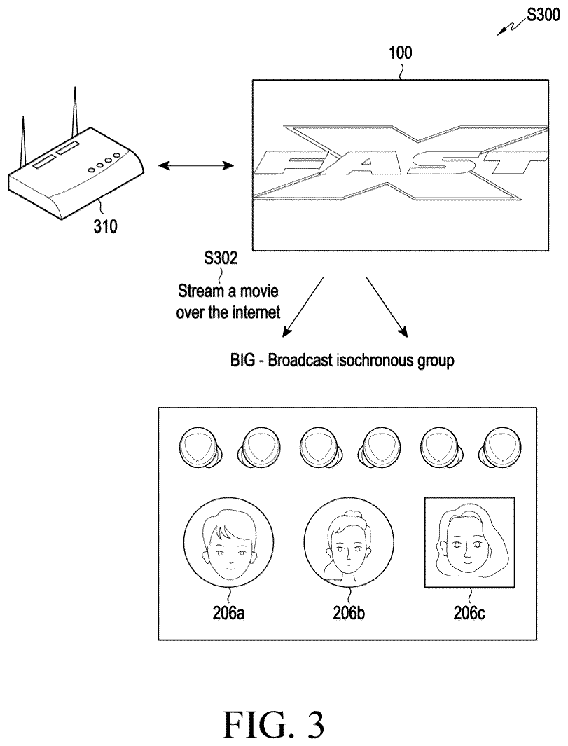

It may be noted that to the extent possible, like reference numerals have been used to represent like elements in the drawing. Further, those of ordinary skill in the art will appreciate that elements in the drawing are illustrated for simplicity and may not have been necessarily drawn to scale. For example, the dimension of some of the elements in the drawing may be exaggerated relative to other elements to help to improve the understanding of aspects of the disclosure. Furthermore, the one or more elements may have been represented in the drawing by conventional symbols, and the drawings may show only those specific details that are pertinent to the understanding the embodiments of the disclosure so as not to obscure the drawing with details that will be readily apparent to those of ordinary skill in the art having benefit of the description herein.

### DETAILED DESCRIPTION

The example embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The description herein is intended merely to facilitate an understanding of ways in which the example embodiments herein may be practiced and to further enable those of skill in the art to practice the example embodiments herein. Accordingly, this disclosure should not be construed as limiting the scope of the example embodiments herein.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The accompanying drawings are used to help easily understand various technical features and it should be understood that the embodiments presented herein are not limited by the accompanying drawings. As such, the disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

In the disclosure, the expressions “A or B,” “at least one of A and/or B,” or “one or more of A and/or B,” and the like include all possible combinations of the listed items. For example, “A or B,” “at least one of A and B,” or “at least one of A or B” includes (1) at least one A, (2) at least one B, (3) at least one A and at least one B all together.

The embodiments herein achieve a method for managing dynamic codec configuration of audio stream. The method includes broadcasting, by a transmitter device, the audio stream in a first codec configuration to at least one receiver device of a plurality of receiver devices. Further, the method includes detecting, by the transmitter device, an event to change the first codec configuration of the audio stream while the transmitter device is broadcasting the audio stream. Further, the method includes determining, by the transmitter device, a second codec configuration and a timing information for the ongoing broadcast audio stream based on the detected event. The second codec configuration is different than the first codec configuration. The timing information indicates a time at which the second codec configuration is to be used by the at least one receiver device. Further, the method includes sending, by the transmitter device, a control packet to the at least one receiver device to modify the first codec configuration of the audio stream at the at least one receiver device while the audio stream is broadcasted by the transmitter device. The control packet includes the second codec configuration and the timing information.

In contrast to traditional approaches, the suggested technique enables a flexible reorganization of the LE audio broadcast isochronous stream in accordance with the audio content at hand. This functionality promises to heighten the user's overall experience in the LE audio broadcast scenario. Specifically, the proposed method empowers the transmitting device to adjust the broadcasted audio's bitrate dynamically, should a change in audio context be detected. This adjustment is performed seamlessly, without causing any disruptions to audio or video synchronization. Furthermore, the proposed method ensures that the receiver device may resynchronize itself with the updated Periodic Advertisement without interruption, when a change in audio context be detected on the transmitting device.

The proposed methodology enables the transmitter device to seamlessly adjust the audio bitrate being broadcasted in response to changes in bandwidth or RF conditions, thereby ensuring a seamless user experience without any choppiness. Similarly, the proposed methodology also enables the receiver device to effortlessly resynchronize with the updated Periodic Advertisement in the event of changes in the codec configuration of the transmitter device.

The disclosure facilitates the real-time alteration of codec for an ongoing low-power audio broadcast isochronous stream. Upon recognizing the requirement to switch codec, the transmitting device utilizes the proposed method to dispatch BIG_CODEC_CONFIG_UPDATE_IND in the BIG control PDU to the receiving device. Thus, results in enabling the transmitting device to relay the codec configuration details to the recipient device, including timing information for usage. As a result, the receiving device will appropriately adjust the codec configuration as necessary. The innovative approach supports the dynamic reconfiguration of codec in LE audio devices, removing the need for manual restart of the audio broadcast and allowing for seamless background processing.

Upon receipt of the BIG control PDU, the receiving device optimizes the PA skip parameter and sync timeout parameter to ensure receipt of updated PA from the transmitting device. This shall enable seamless switch to updated codec configuration.

The transmitter device sends the periodic advertisement packet including broadcast audio Stream endpoint information, ISO_Interval, NSE, Sub_Interval, BIS spacing, Max PDU, MaxSDU, Pre-Transmission Offset, Immediate Repetition Count, BN, NSE based on updated codec configuration.

When the transmitter device is in a streaming state, the transmitter device is capable of detecting any changes in the content or quality. Once a change is detected, the transmitter sends a reconfigure request to the codec configuration controller. The codec configuration controller in turn sends a BIG control PDU to indicate any updated codec configuration and instant event. The receiver device, upon receiving the BIG control PDU, initiates a PA_Sync reconfigure procedure. Using the skip parameter and sync timeout, the receiver device optimizes the PA interval for faster resync. Once the updated PA is synchronized, the receiver device sends a broadcast state Ntf to the broadcast assistant device to confirm successful synchronization. Finally, the receiver device resynchronizes to the updated BIG.

In the event of changes in context, such as transitioning from a game to media or vice versa, the active application will trigger the transmitter device to seamlessly adapt to a different codec setting, ensuring optimal audio configuration for the user. Similarly, in the event of significant interference detected by the transmitter device due to the coexistence of multiple devices operating within the same frequency band as Bluetooth, such as Wi-Fi, the transmitter device will automatically switch to a different codec setting. This is necessary as the number of usable channels is reduced, thus ensuring uninterrupted streaming under an optimal codec setting.

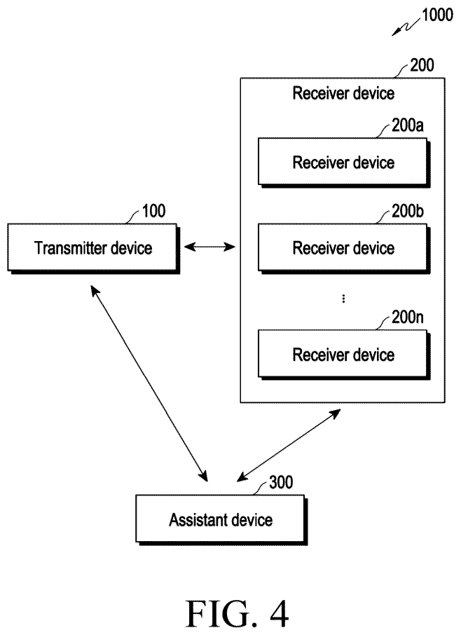

Referring now to the drawings, and more particularly to FIGS. 4 through 25, where similar reference characters denote corresponding features consistently throughout the figures, there are shown example embodiments.

FIG. 4 illustrates an overview of a system (1000) for managing dynamic codec configuration of an audio stream, according to the embodiments as disclosed herein. In an embodiment, the system (1000) includes a transmitter device (100), a plurality of receiver device (200a-200n) and an assistant device (300). Hereafter, the label of the receiver device is 200.

The transmitter device (100) may be, for example, but not limited to a laptop, a notebook, a vehicle to everything (V2X) device, a smartphone, a head mounted display, a foldable phone, a smart TV, a tablet, an immersive device, augmented reality (AR) apparatus, a mixed reality (MR) apparatus, a virtual reality (VR) apparatus, a metaverse apparatus, and an internet of things (IoT) device. The transmitter device (100) may also be called as a broadcast source, transmitter or the like.

The receiver device (200) may be, for example, but not limited to an XR headset, wireless buds (e.g., true wireless stereo (TWS) buds) or the like. The receiver device (200) may also be called as a broadcast receiver, a broadcast sink, receiver or the like. The assistant device (300) may be, for example, but not limited to the smart phone, the laptop or the like.

The transmitter device (100) broadcasts an audio stream (e.g., low-energy audio broadcast isochronous stream) in a first codec configuration to the receiver device (200) of the plurality of receiver devices (200). In an embodiment, the transmitter device (100) advertises near to the assistant device (300) to enable a user to select the transmitter device (100). Further, the transmitter device (100) sends advertisement information and audio streams to the assistant device (300) once the user selects the transmitter device (100). In another words, the transmitter device (100) keeps sending the advertisement information and audio streams. But, the transmitter device (100) is not connected to any assistant device (300) and just keeps broadcasting the advertisement information and the audio streams. The assistant device (300) scans for nearby transmitter devices, and when the user selects the transmitter device (100). The assistant device (300) sends synchronization information to the receiver devices (200) which help receiver devices (200) to listen to the audio stream. The advertisement information includes a name, content, the first codec configuration and audio streams including left stereo audio streams and right stereo audio streams. Further, the transmitter device (100) sends the advertisement information and the audio streams to the receiver device (200). Further, the transmitter device (100) synchronizes the audio streams at the transmitter device (100) with the receiver device (200) based on the advertisement information and the audio streams from the transmitter device (100) to receive the audio stream in the first codec configuration.

Further, the transmitter device (100) detects an event to change the first codec configuration of the audio stream while the transmitter device (100) is broadcasting the audio stream. The event may be, for example, but not limited to at least one of a change in a content format indicating a quality of the ongoing broadcast audio stream, an audio context of the ongoing broadcast audio stream, and a radio frequency channel assessment indicating a congestion level of the ongoing broadcast audio stream.

Further, the transmitter device (100) determines a second codec configuration and a timing information for the ongoing broadcast audio stream based on the detected event. The second codec configuration is different than the first codec configuration. The timing information indicates a time at which the second codec configuration is to be used by the receiver device (200). The first codec configuration is dynamically modified to the second codec configuration of the audio stream at the receiver device (200) without restarting broadcast of the audio stream from the transmitter device (100).

Further, the transmitter device (100) sends a control packet to the receiver device (200) to modify the first codec configuration of the audio stream at the receiver while the audio stream is broadcasted by the transmitter device (100). The control packet includes the second codec configuration and the timing information.

Based on the second codec configuration, the transmitter device (100) sends a BIG control packet to the receiver device (200). The BIG control packet includes an opcode field identifying a type of control packet, and an instant field indicating the BIG event at which new codec configuration is applied and updated codec configuration data.

In another embodiment, the transmitter device (100) determines the need to update codec configuration for ongoing low-energy audio broadcast isochronous stream. Based on the determination, the transmitter device (100) sends the control packet to the receiver (200), where the control packet includes an updated codec configuration and timing information on when to use the updated codec configuration.

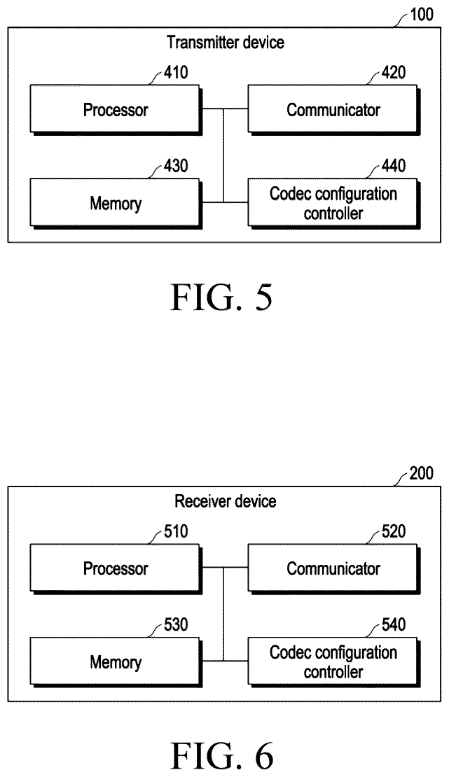

FIG. 5 is a block diagram illustrating various hardware components of the transmitter device (100), according to the embodiments as disclosed herein. In an embodiment, the transmitter device (100) includes a processor (410), a communicator (420), a memory (430), and a codec configuration controller (440). The processor (410) is communicatively coupled with the communicator (420), the memory (430), and the codec configuration controller (440).

The codec configuration controller (440) broadcasts the audio stream (e.g., low-energy audio broadcast isochronous stream) in the first codec configuration to the receiver device (200). In an embodiment, the codec configuration controller (440) advertises the transmitter device (100) when the transmitted device (100) is near to the assistant device (300) to enable a user to select the transmitter device (100). Further, the codec configuration controller (440) sends advertisement information and audio streams to the assistant device (300) once the user select the transmitter device (100). The advertisement information includes a name, content, the first codec configuration and audio streams including left stereo audio streams and right stereo audio streams. Further, the codec configuration controller (440) sends the advertisement information and the audio streams to the receiver device (200). Further, the codec configuration controller (440) synchronizes the audio streams at the transmitter device (100) with the receiver device (200) based on the advertisement information and the audio streams from the transmitter device (100) to receive the audio stream in the first codec configuration.

Further, the codec configuration controller (440) detects an event to change the first codec configuration of the audio stream while the transmitter device (100) is broadcasting the audio stream. The event may be, for example, but not limited to a change in a content format indicating a quality of the ongoing broadcast audio stream, an audio context of the ongoing broadcast audio stream, and a radio frequency channel assessment indicating a congestion level of the ongoing broadcast audio stream.

Further, the codec configuration controller (440) determines a second codec configuration and timing information for the ongoing broadcast audio stream based on the detected event. The second codec configuration is different than the first codec configuration. The timing information indicates a time at which the second codec configuration is to be used by the receiver device (200). The first codec configuration is dynamically modified to the second codec configuration of the audio stream at the receiver device (200) without restarting broadcast of the audio stream from the transmitter device (100).

Further, the codec configuration controller (440) sends a control packet to the receiver device (200) to modify the first codec configuration of the audio stream at the receiver while the audio stream is broadcasted by the transmitter device (100). The control packet includes the second codec configuration and the timing information.

Based on the second codec configuration, the codec configuration controller (440) sends a BIG control packet to the receiver device (200). The BIG control packet includes an opcode field identifying a type of control packet, and an instant field indicating the BIG event at which new codec configuration is applied and updated codec configuration data.

The codec configuration controller (440) is physically implemented by analog or digital circuits such as logic gates, integrated circuits, microprocessors, microcontrollers, memory circuits, passive electronic components, active electronic components, optical components, hardwired circuits, or the like, and may optionally be driven by firmware.

Further, the processor (410) is configured to execute instructions stored in the memory (430) and to perform various processes. The communicator (420) is configured for communicating internally between internal hardware components and with external devices via one or more networks. The memory also stores instructions to be executed by the processor (410). The memory may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory may, in some examples, be considered a non-transitory storage medium. The term “non-transitory” may indicate that the storage medium is not embodied in a carrier wave or a propagated signal. However, the term “non-transitory” should not be interpreted that the memory is non-movable. In certain examples, a non-transitory storage medium may store data that may, over time, change (e.g., in random access memory (RAM) or cache).

Further, at least one of the plurality of modules/controllers may be implemented through the AI model using the data driven controller. The data driven controller may be a ML model based controller and AI model based controller. A function associated with the AI model may be performed through the non-volatile memory, the volatile memory, and the processor (410). The processor (410) may include one or a plurality of processors. At this time, one or a plurality of processors may be a general purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU).

The one or a plurality of processors control the processing of the input data in accordance with a specified operating rule or AI model stored in the non-volatile memory and the volatile memory. The specified operating rule or artificial intelligence model is provided through training or learning.

Here, being provided through learning means that a specified operating rule or AI model of a desired characteristic is made by applying a learning algorithm to a plurality of learning data. The learning may be performed in a device itself in which AI according to an embodiment is performed, and/o may be implemented through a separate server/system.

The AI model may comprise of a plurality of neural network layers. Each layer has a plurality of weight values, and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

The learning algorithm is a method for training a predetermined target device (for example, a robot) using a plurality of learning data to cause, allow, or control the target device to make a determination or prediction. Examples of learning algorithms include, but are not limited to, supervised learning, unsupervised learning, semi-supervised learning, or reinforcement learning.

Although FIG. 5 shows various hardware components of the transmitter device (100) but it is to be understood that other embodiments are not limited thereon. In other embodiments, the transmitter device (100) may include less or more number of components. Further, the labels or names of the components are used only for illustrative purpose and does not limit the scope of the disclosure. One or more components may be combined together to perform same or substantially similar function in the transmitter device (100).

FIG. 6 is a block diagram illustrating various hardware components of the receiver device (200), according to the embodiments as disclosed herein. In an embodiment, the receiver device (200) includes a processor (510), a communicator (520), a memory (530), a codec configuration controller (540). The processor (510) is communicatively coupled with the communicator (520), the memory (530), and the codec configuration controller (540).

The codec configuration controller (540) receives the audio stream in the first codec configuration broadcasted by the transmitter device (100). Further, the codec configuration controller (540) receives the control packet from the transmitter device (100) to modify the first codec configuration of the audio stream. The control packet includes the second codec configuration and timing information and the timing information of the control packet indicates the time at which the second codec configuration is to be used. Further, the codec configuration controller (540) dynamically modifies the first codec configuration to the second codec configuration of the audio stream based on the timing information received in the control packet while receiving the audio stream broadcasted by the transmitter device (100).

In an embodiment, the codec configuration controller (540) receives a BIG control packet from the transmitter device (100) based on the second codec configuration. Further, the codec configuration controller (540) updates the skip parameter and the synchronization timeout parameter subsequent to receiving the BIG control packet from the transmitter device (100). Further, the codec configuration controller (540) initiates the reconfiguration of the PA synchronization procedure parameters once the first codec configuration is modified to the second codec configuration. The PA synchronization is performed based on the updated skip parameter and the updated synchronization timeout parameter.

In an embodiment, the codec configuration controller (540) activates a host controller interface (HCI) command after initiation of the reconfiguration of the PA synchronization. Further, the codec configuration controller (540) broadcasts a notification to the assistant device (300). The notification represents the receiver device (200) is synchronized to the second codec configuration. Further, the codec configuration controller (540) reconfigures an isochronous data path. Further, the codec configuration controller (540) receives the BIG control packet with respect to the second codec configuration from the transmitter device (100).

The codec configuration controller (540) is physically implemented by analog or digital circuits such as logic gates, integrated circuits, microprocessors, microcontrollers, memory circuits, passive electronic components, active electronic components, optical components, hardwired circuits, or the like, and may optionally be driven by firmware.

Further, the processor (510) is configured to execute instructions stored in a memory and to perform various processes. The communicator (520) is configured for communicating internally between internal hardware components and with external devices via one or more networks. The memory (530) also stores instructions to be executed by the processor (510). The memory (530) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (530) may, in some examples, be considered a non-transitory storage medium. The term “non-transitory” may indicate that the storage medium is not embodied in a carrier wave or a propagated signal. However, the term “non-transitory” should not be interpreted that the memory (530) is non-movable. In certain examples, a non-transitory storage medium may store data that may, over time, change (e.g., in RAM or cache).

Further, at least one of the plurality of modules/controllers may be implemented through the AI model using the data driven controller. The data driven controller may be a ML model based controller and AI model based controller. A function associated with the AI model may be performed through the non-volatile memory, the volatile memory, and the processor (510). The processor (510) may include one or a plurality of processors. At this time, one or a plurality of processors may be a general purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU).

The one or a plurality of processors control the processing of the input data in accordance with a specified operating rule or AI model stored in the non-volatile memory and the volatile memory. The specified operating rule or artificial intelligence model is provided through training or learning.

Here, being provided through learning means that a specified operating rule or AI model of a desired characteristic is made by applying a learning algorithm to a plurality of learning data. The learning may be performed in a device itself in which AI according to an embodiment is performed, and/o may be implemented through a separate server/system.

The AI model may comprise of a plurality of neural network layers. Each layer has a plurality of weight values, and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann machine (RBM), deep belief network (DBN), bidirectional recurrent deep neural network (BRDNN), generative adversarial networks (GAN), and deep Q-networks.

The learning algorithm is a method for training a predetermined target device (for example, a robot) using a plurality of learning data to cause, allow, or control the target device to make a determination or prediction. Examples of learning algorithms include, but are not limited to, supervised learning, unsupervised learning, semi-supervised learning, or reinforcement learning.

Although FIG. 6 shows various hardware components of the receiver device (200) but it is to be understood that other embodiments are not limited thereon. In other embodiments, the receiver device (200) may include less or more number of components. Further, the labels or names of the components are used only for illustrative purpose and does not limit the scope of the disclosure. One or more components may be combined together to perform same or substantially similar function in the receiver device (200).

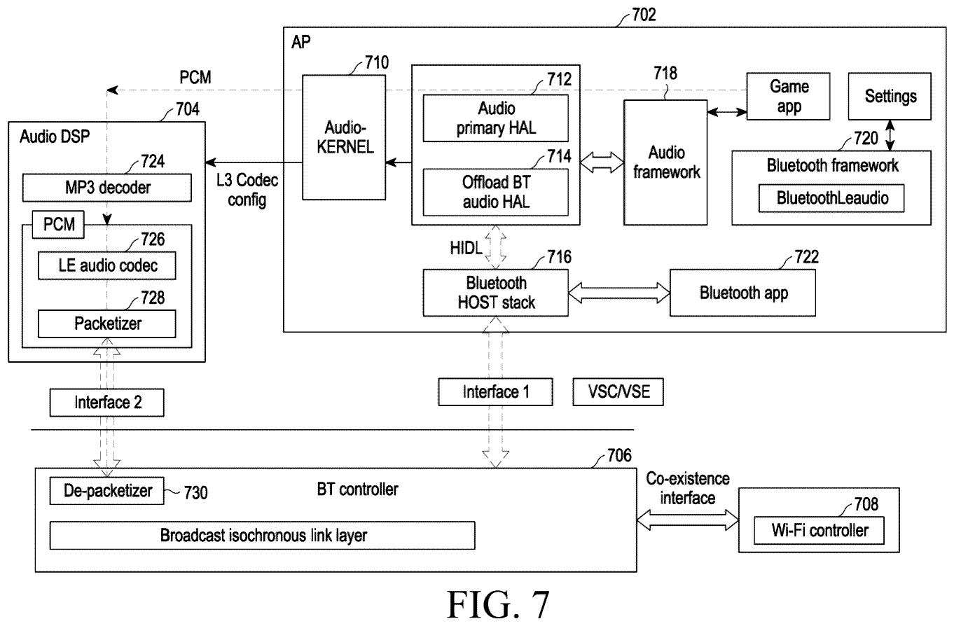

FIG. 7 is a block diagram illustrating an internal hardware component of the transmitter device (100), according to the embodiments as disclosed herein. The transmitter device (100) includes an application processor (AP) (702), an audio digital signal processor (DSP) (704), a Bluetooth (BT) controller (706) and a Wi-Fi controller (708). The AP (702), the audio DSP (704), the BT controller (706) and the Wi-Fi controller (708) communicate with each other. In the internal architecture, an first interface (i.e. interface 1) represents an interface between a BT host stack (716) in the AP (702) and the BT controller (706). The LE audio codec (726) resides in the audio DSP (704). A second interface (i.e., interface 2) is an interface between the audio DSP (704) and the BT controller (706). The Bluetooth host stack (716) is responsible to configure the Bluetooth controller (706) with the updated QoS configuration based on the audio context and RF conditions.

Further, the Bluetooth host stack (716) is responsible to configure the audio DSP (704) with new codec configuration. Further, the Bluetooth host stack (716) is responsible to configure the Bluetooth controller (706) with new periodic advertisement data. Further, the Bluetooth host stack (716) is responsible to send command to the Bluetooth controller (706) to initiate reconfiguration procedure to send BIG control PDU. A BT audio HAL (not shown) receives channel quality information from the Bluetooth host stack (716) and configures the audio DSP (704) with codec configuration to meet the audio quality requirements (e.g., sampling frequency, frame duration, Octets per codec frame).

In a Bluetooth host stack (716), the HCI ISO control and HCI interface are provided in the BT controller (706). In the Bluetooth host stack (716), new HCI vendor specific event informs the Bluetooth host stack (716) when there is change in the RF channel map and interference status and a new HCI vendor specific command from the Bluetooth host stack (716) to the BT controller (706) starts the reconfiguration procedure.

The BT controller (706) is responsible to detect co-existence problems and notify the Bluetooth host stack (716) with details like RF channel map status, interference metrics. Further, the BT controller (706) is responsible to start reconfiguration procedure by sending the BIG control PDU. The BT controller (706) is responsible to send request command to audio DSP (704) to send packets with updated codec setting. The BT controller (706) is responsible to send updated periodic advertisement packet based on the timing information (instant parameter) sent in BIG control PDU.

Further, the AP (702) includes an audio kernel (710), an audio primary HAL (712), an offload BT audio HAL (714), a Bluetooth host stack (716), an audio framework (718), a Bluetooth framework (720), and a Bluetooth application (722). The Bluetooth application (722) is communicated with the Bluetooth host stack (716). The Bluetooth host stack (716) communicates with the audio primary HAL (712) and the offload BT audio HAL (714). The audio primary HAL (712) and the offload BT audio HAL (714) communicate with the audio framework (718) and the audio kernel (710).

Further, a MP3 decoder (724), an LE audio codec (726) and a packetizer (728) are included in the audio DSP (704). A de-packetizer (730) is included in the BT controller (706). The BT controller (706) is communicated with the AP (702) through an interface-1. The BT controller (706) is communicated with the audio DSP (704) through an interface-2. The BT controller (706) is communicated with the Wi-Fi controller (708) through the co-existence interface.

Although FIG. 7 shows various hardware components of the transmitter device (100) but it is to be understood that other embodiments are not limited thereon. In other embodiments, the transmitter device (100) may include less or more number of components. Further, the labels or names of the components are used only for illustrative purpose and does not limit the scope of the disclosure. One or more components may be combined together to perform same or substantially similar function in the transmitter device (100).

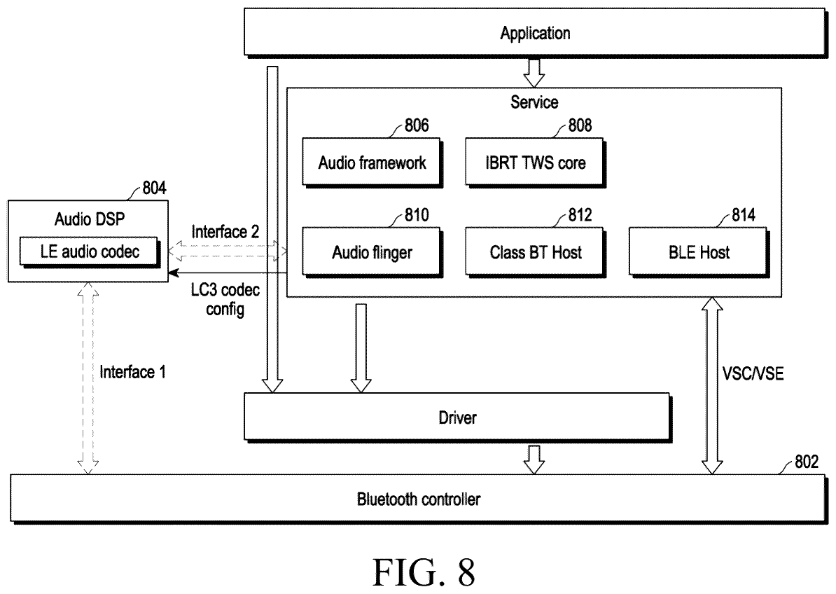

FIG. 8 is a block diagram illustrating internal hardware components of the receiver device (200), according to the embodiments as disclosed herein. The receiver device (200) includes the Bluetooth controller (802), an audio DSP (804), an audio framework (806), an IBRT TWS core (808), an audio flinger (810), a classic BT host (812), and a BLE host (814). The Bluetooth controller (802), the audio DSP (804), the audio framework (806), the IBRT TWS core (808), the audio flinger (810), the classic BT host (812), and the BLE host (814) communicate with each other.

A first interface (i.e. interface 1) is the interface between the audio DSP (804) and the BT controller (802). The LE audio codec resides in the audio DSP (804). A second interface (i.e. interface 2) is the data path interface between the audio DSP (804) and the audio flinger (810) to receive the decoded audio packets. The BLE host (814) receives indication from the controller regarding reconfiguration request from the transmitter device (100) with updated codec configuration.

The audio flinger (810) receives the new codec setting from the classic BT host (812) and configures the audio DSP (804) to instantiate a new decoder instance with new codec configuration such as (sampling frequency, frame duration, Octets per codec frame). The Bluetooth host stack detects the new HCI vendor specific event when there is change in codec configuration informed by the BT controller (802). The BT controller (802) is responsible to receive BIG control PDU and process it to identify new codec configuration and timing instant when it will take effect. Further, the BT controller (802) is responsible to receive updated periodic advertisement packet based on the timing information (instant parameter) sent in the BIG control PDU and inform the classic BT host (812). Further, the BT controller (802) is responsible to receive the encoded audio packets from the transmitter device (100) and process it as per updated BIGInfo in new periodic advertisement packet. Further, the BT controller (802) is responsible to send request command to the audio DSP (804) to decode packets with updated codec setting.

Although FIG. 8 shows various hardware components of the receiver device (200) but it is to be understood that other embodiments are not limited thereon. In other embodiments, the receiver device (200) may include less or more number of components. Further, the labels or names of the components are used only for illustrative purpose and does not limit the scope of the disclosure. One or more components may be combined together to perform same or substantially similar function in the receiver device (200).

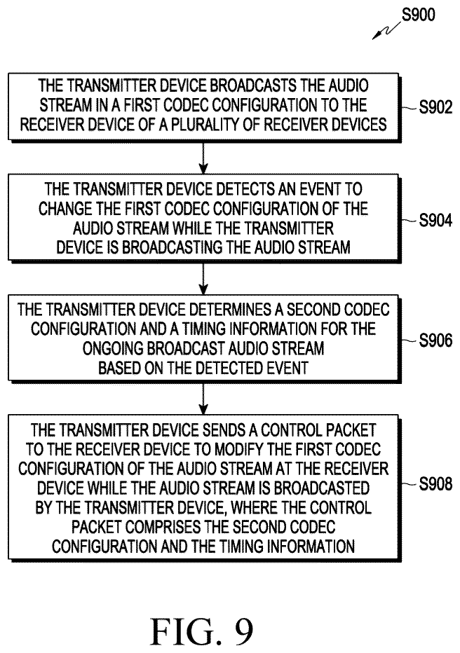

FIG. 9 is a flow chart (S900) illustrating a method, implemented by the transmitter device (100), for managing the dynamic codec configuration of the audio stream, according to the embodiments as disclosed herein. The operations (S902-S908) are handled by the codec configuration controller (440).

At S902, the method includes broadcasting the audio stream in the first codec configuration to at least one receiver device (200) of the plurality of receiver devices. At S904, the method includes detecting the event to change the first codec configuration of the audio stream while the transmitter device (100) is broadcasting the audio stream. At S906, the method includes determining the second codec configuration and the timing information for the ongoing broadcast audio stream based on the detected event. The second codec configuration is different than the first codec configuration. The timing information indicates a time at which the second codec configuration is to be used by the at least one receiver device (200). At S908, the method includes sending the control packet to the at least one receiver device (200) to modify the first codec configuration of the audio stream at the at least one receiver device (200) while the audio stream is broadcasted by the transmitter device (100). The control packet includes the second codec configuration and the timing information.

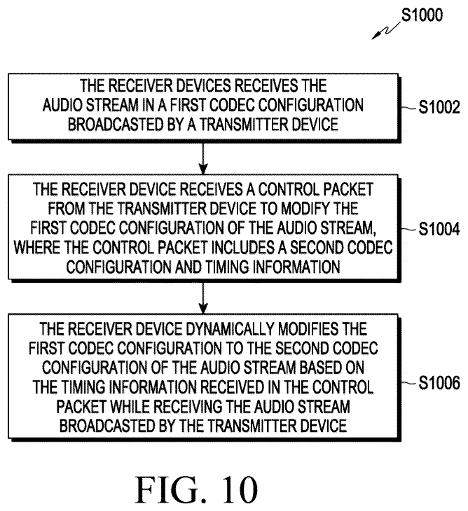

FIG. 10 is a flow chart (S1000) illustrating a method, implemented by the receiver device (200), for managing the dynamic codec configuration of the audio stream, according to the embodiments as disclosed herein. The operations (S1002-S1006) are handled by the codec configuration controller (540).

At S1002, the method includes receiving the audio stream in a first codec configuration broadcasted by a transmitter device (100). At S1004, the method includes receiving the control packet from the transmitter device (100) to modify the first codec configuration of the audio stream. The control packet includes the second codec configuration and timing information. The second codec configuration is different than the first codec configuration. The timing information of the control packet indicates a time at which the second codec configuration is to be used. At S1006, the method includes dynamically modifying the first codec configuration to the second codec configuration of the audio stream based on the timing information received in the control packet while receiving the audio stream broadcasted by the transmitter device (100).

The method allows the transmitter device (100) to dynamically reconfigure an ongoing which is already in a streaming state. The transmitter device (100) uses control subevent to send a control message to update codec configuration on all receiver devices (200). The message also includes the timing instant when the new configuration will take effect.

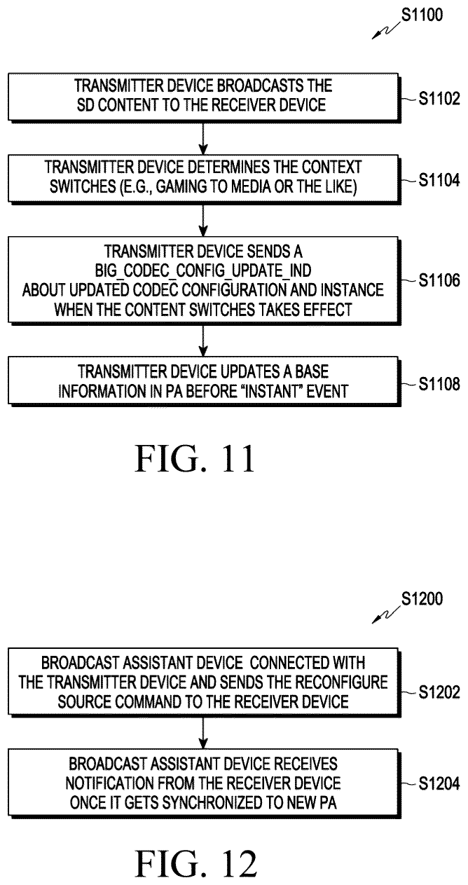

FIG. 11 is an example flow chart (S1100) illustrating a method, implemented by the transmitter device (100), for managing the dynamic codec configuration of the audio stream, according to the embodiments as disclosed herein. The operations (S1102-S1108) are handled by the codec configuration controller (440).

At S1102, the transmitter device (100) broadcasts the SD content to the receiver device (200). At S1104, the transmitter device (100) performs the context switches (e.g., gaming event). At S1106, the transmitter device (100) sends BIG_CODEC_CONFIG_UPDATE_IND about updated codec configuration and instance when the events takes effect. At S1108, the transmitter device (100) updates broadcast audio stream endpoint (BASE) information in PA before “instant” event (e.g. the instance when the event takes effect).

FIG. 12 is an example flow chart (S1200) illustrating a method, implemented by the assistant device (300), for managing the dynamic codec configuration of the audio stream, according to the embodiments as disclosed herein.

At S1202, the assistant device (300) collocates the transmitter device (100) and sends the reconfigure source command to the receiver device (200). At S1204, the assistant device (300) receives notification from the receiver device (200) once the receiver device (200) is synchronized to new PA.

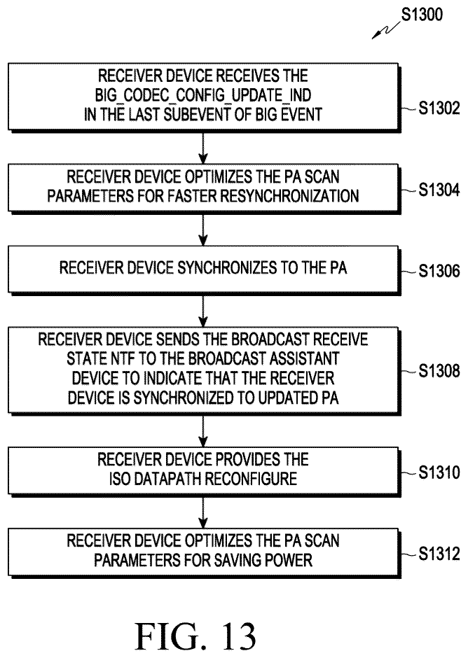

FIG. 13 is an example flow chart (S1300) illustrating a method, implemented by the receiver device (200), for managing the dynamic codec configuration of the audio stream, according to the embodiments as disclosed herein.

At S1302, the receiver device (200) receives the BIG_CODEC_CONFIG_UPDATE_IND in the last subevent of BIG event. At S1304, the receiver device (200) optimizes the PA scan parameters for faster re-synchronisation. At S1306, the receiver device (200) synchronizes to the PA. At S1308, the receiver device (200) sends broadcast receive state Ntf to the assistant device (300) to indicate that the receiver device (200) is synchronized to updated PA. At S1310, the receiver device (200) provides the ISO data-path reconfigure. At S1312, the receiver device (200) optimizes the PA scan parameters for saving power.

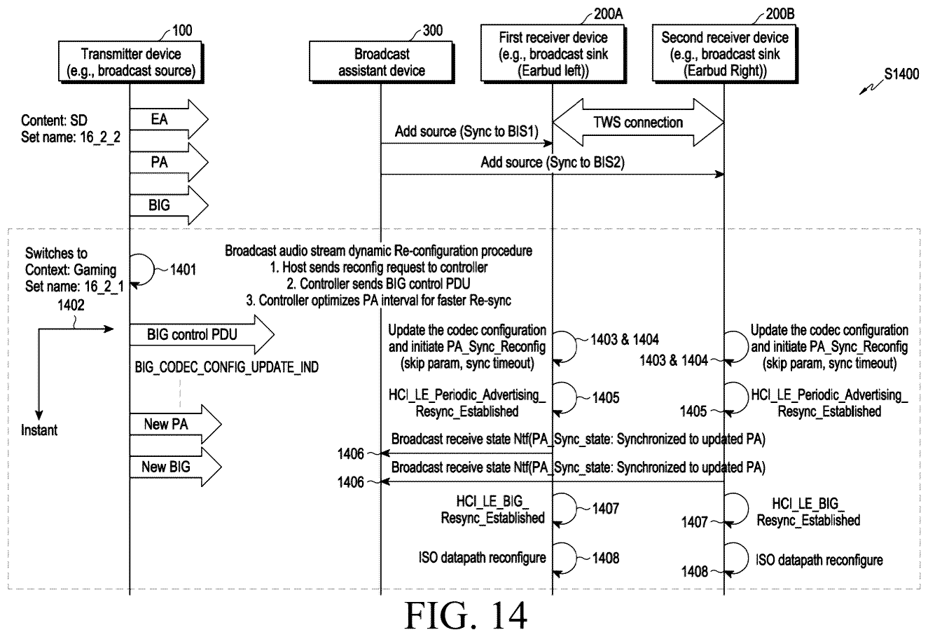

FIG. 14 illustrates a sequence diagram (S1400) illustrating the transmitter device (100) (e.g., broadcast source or the like) initiating a request for reconfiguration to the receiver device (200a and 200b) and the request includes the latest codec configuration and real-time event updates, accordingly to embodiments as disclosed herein.

At operation 1401, at first, the transmitter device (100) will detect the audio content change and it will send reconfigure request to the codec configuration controller (440).

At operation 1402, the codec configuration controller (440) will transmit the BIG control PDU in the control subevent of a BIG event to indicate information about updated codec configuration and instant event. The BIG control PDU stands for protocol data unit and the BIG stands for broadcast isochronous group. So the BIG control PDU is a type of broadcast isochronous PDU (BIS PDU) that is used to send control information for the BIG. Further, the codec configuration controller (440) optimizes the PA interval for faster resynchronization.

At operation 1403, the receiver device (200a and 200b) will receive the BIG control PDU and initiate PA_Sync reconfigure procedure. The PA_Sync reconfigure procedure is the PA synchronization reconfiguration procedure on the receiver device (200a and 200b) that will use skip parameter to optimize PA interval for faster resync.

At operation 1404, after receiving the BIG control PDU, the receiver device (200a and 200b) will configure its codec configuration controller (540) using the skip parameter. The skip parameter specifies the maximum number of consecutive periodic advertising events that the receiver device (200a and 200b) may skip the skip parameter after successfully receiving a periodic advertising packet. The skip parameter defines the maximum permitted time between successful PA received.

At operation 1405, after resynchronizing to the updated PA, the receiver device (200a and 200b) sends a HCI command (e.g., HCI_LE_Periodic_Advertising_Resync_Established) to indicate that it has successfully resynchronized to the updated PA of transmitter device (100). The HCI_LE_Periodic_Advertising_Resync_Established is the HCI command indicating the receiver device (200a and 200b) have established resynchronization to the updated PA

At operation 1406, now, the receiver device (200a and 200b) will send broadcast receive state notification to the assistant device (300) with PA_sync state: Synchronized to updated PA, to inform the assistant device (300) that it has successfully resynchronized to the updated PA.

At operation 1407, at last, the receiver device (200a and 200b) will to the updated BIG and send HCI command resynchronize (HCI_LE_BIG_Resync_Established) which BIG. The indicates the updated HCI_LE_BIG_Resync_Established is the HCI command indicating the receiver device (200a and 200b) have established resynchronization to the updated BIG. At operation 1408, the receiver device (200a and 200b) performs the ISO data path reconfigure.

After following all these operations (1401-1408), the transmitter device (100) is able to successfully reconfigure the codec configuration of broadcast isochronous stream dynamically, while still being in streaming state and the receiver device (200a and 200b) is also able to resynchronize back to the updated stream seamlessly.

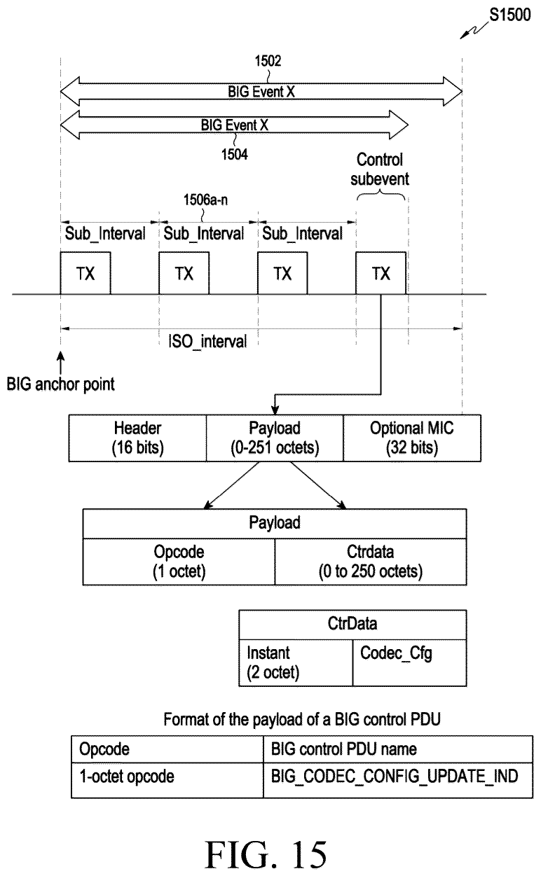

FIG. 15 illustrates a generic packet format (S1500) of the broadcast isochronous PDU and format of a payload field in the BIG control PDU, according to the embodiments as disclosed herein. The broadcast isochronous PDU (BIS PDU) may be either BIS data PDU or BIG control PDU. The BIS data PDU is used to carry isochronous data and the BIG control PDU is used to send control information for the BIG.

The transmitter device (100) transmits the BIG control PDU in the control subevent of the BIG event (1502) to indicate information about updated codec configuration and instant event. In the BIG event (1502), there is one BIS event (1504) and one BIG control PDU. The BIS event (1504) consists of several BIS subevents (1506ₐ-1506ₙ). The BIG control PDU is transmitted after the final subevent of the last BIS. The transmitter device (100) makes use of the BIG control PDU to broadcast control information to all the synchronized receiver devices indicating the updated codec configuration and the instant event. A CtrData field in the BIG control PDU is specified by the Opcode field. For a given Opcode, the length of the CtrData field is fixed. The description of a field within the CtrData field gives a range of valid values or other restrictions on a value. The BIG control PDU contains the opcode field identifying the type of control packet and CtrData field which further contains instant field indicating the BIG event at which new codec configuration is applied and updated codec configuration data. The format of the CtrData field is shown below:

TABLE 1
CtrData

| | |
|---|---|
| Instant (2 octet) | Codec_Cfg |

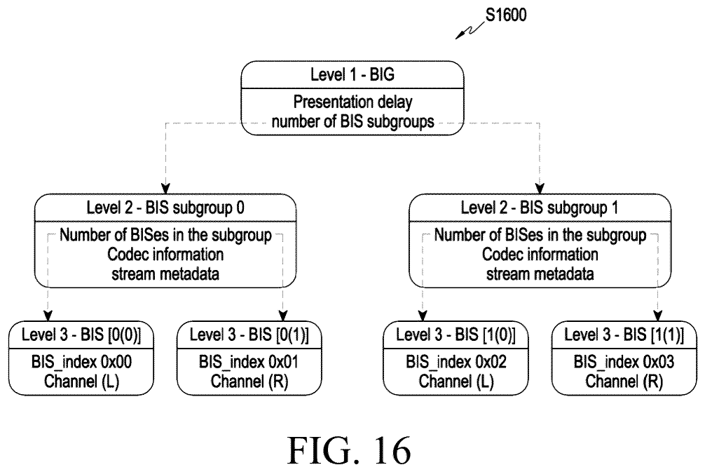

FIG. 16 illustrates (S1600) a codec configuration structure, according to the embodiments as disclosed herein.

The format of the CtrData field is shown as the Instant field that shall define the value of bigEventCounter₁₅₋₀. The counter value defines the BIG data event for which the new codec configuration would be applied. In this way, the transmitter device (100) may define the time instant at which the codec should be applied. The Codec_Cfg field will consist of the entire BASE (broadcast audio stream endpoint) structure, and the size is not fixed. The field will indicate the codec configuration that needs to be changed in the receiver device (200).

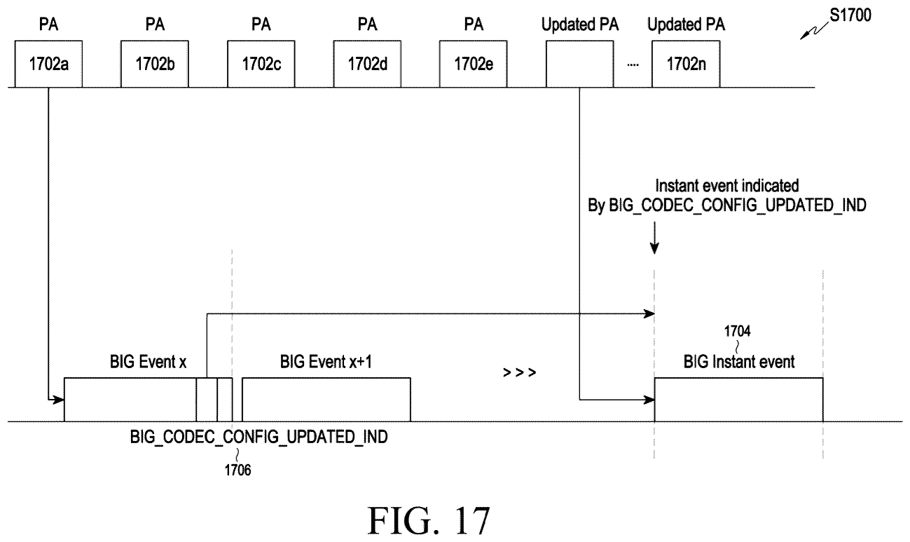

FIG. 17 illustrates example time reference (S1700) pertaining to the BIG_CODEC_CONFIG_UPDATE_IND (1706), according to the embodiments as disclosed herein. FIG. 17 shows the time reference diagram of BIG_CODEC_CONFIG_UPDATE_IND sent by the transmitter device (100) during dynamic reconfiguration of LE audio BIS procedure. The various block denotes the BIG control PDU (BIG_CODEC_CONFIG_UPDATE_IND), that is transmitted by the transmitter device (100) and receiver received by the synchronized devices (200). The BIG_CODEC_CONFIG_UPDATE_IND (1706) consists of the BIG instant event (1704) and the updated codec configuration. The BIG instant event (1704) is the instant from which the stream will start transmitting with updated configuration. The updated PA (1702a-1702n) is the new periodic advertisement that the transmitter device (100) will transmit after initiating the reconfiguration procedure and sending the BIG_CODEC_CONFIG_UPDATE_IND (1706), it will carry the updated BIGInfo. The updated codec configuration will consist of the updated broadcast audio stream endpoint (BASE) information.

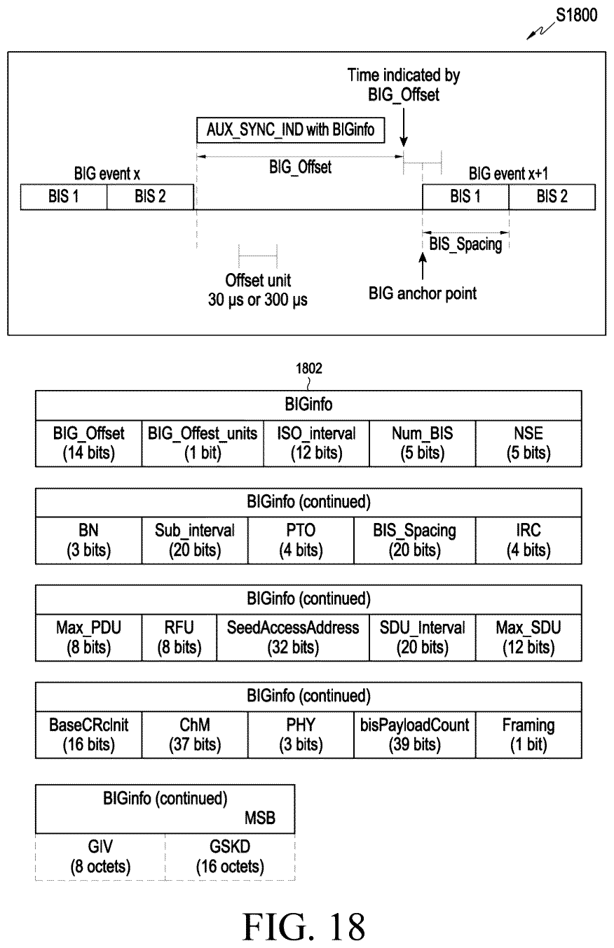

FIG. 18 is an example illustration (S1800) for BIGInfo (1802) describing the BIG streams, while receiving broadcast isochronous streams, according to the embodiments as disclosed herein.

The BIG_Offset field contains the time from the start of the packet containing the BIGInfo (1802) to the next BIG anchor point. The value of the BIG_Offset field is in the unit of time indicated by the BIG_Offset_Units bit and the actual time offset is determined by multiplying the value of BIG_Offset by the unit. If the BIG_Offset_Units bit is set the unit is 300 us and otherwise it is 30 μs. The BIG anchor point shall be no earlier than the offset and no later than the offset plus one unit after the start of the relevant packet (AUX_SYNC_IND). The SeedAccessAddress field shall contain the seed access address for the BIG. The ChM field shall have the same meaning as the corresponding field in the CONNECT_IND PDU. The PHY field shall be set to indicate the PHY used by the BIG. The bisPayloadCount field is used for numbering the payload. The value shall be for the first subevent of the BIG event referred to by the BIG_Offset field.

The BIG parameters include Num_BIS, ISO_Interval, BIS_Spacing, Sub_Interval, Max_PDU, Max_SDU. The Num_BIS: number of BISes in the BIG, each assigned a BIS_Number. ISO_Interval is the time between two adjacent BIG anchor points (5 ms to 4 s). BIS_Spacing is the time between the start of corresponding subevents in adjacent BISes in the BIG. Sub_Interval is the time between the start of two consecutive subevents of each BIS. Max_PDU is the maximum number of data octets (excluding the MIC, if any) that may be carried in each BIS data PDU in the BIG (0 to 251 octets). Max_SDU is the maximum size of an SDU on the BIG (1 to 4095 octets). BN, PTO (“Pre-Transmission Offset”), and IRC (“Immediate Repetition Count”) control which data is transmitted in each BIG event. The value of BN shall be between 1 and 7. The value of PTO shall be between 0 and 15. The value of IRC shall be between 1 and 15. The IRC (immediate repetition count) parameter contains the number of times the scheduled data packet is transmitted in a scheduled event. The IRC parameter shall be an integer in the range 1 to (NSE÷BN). The PTO (Pre_Transmission_Offset) parameter contains the offset in number of ISO_Intervals for pre transmissions of data packets. NSE is the number of subevents per BIS in each BIG event. The value shall be between 1 and 31 and shall be an integer multiple of BN. The framing bit shall be set if the BIG carries framed data.

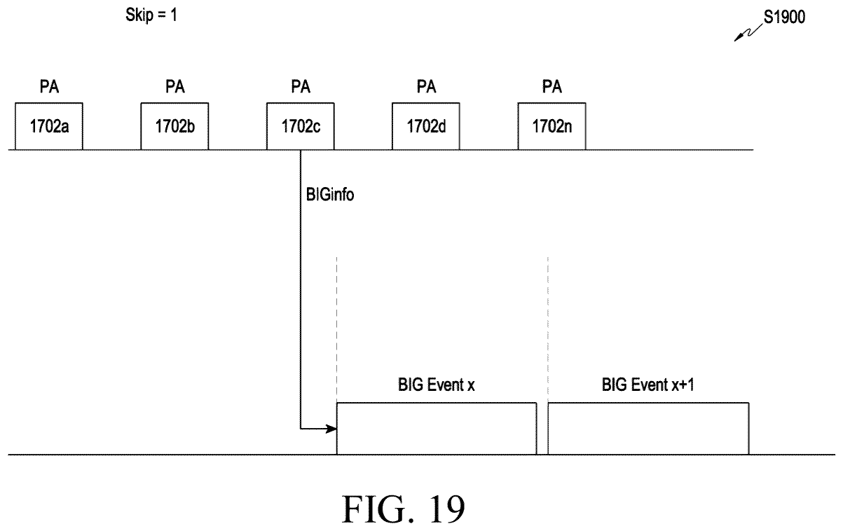

FIG. 19 is illustrates example time reference (S1900) of procedure to optimize PA scan using the skip parameter, according to the embodiments as disclosed herein. FIG. 19 shows the time reference diagram of PA interval optimization using the skip parameter at the receiver device (200) after receiving BIG_CODEC_CONFIG_UPDATE_IND (1706). After receiving the BIG_CODEC_CONFIG_UPDATE_IND (1706), the receiver device (200) knows the updated BIG instant event (1704), based on which it may decide the best value for the skip parameter to save power and as well as optimize the scanning process (because skip parameter allows the receiver device (200) to skip scanning certain PA's and hence saves power). Skip=1 is just taken as example, it could be 2, 3, 4, . . . . Once the receiver device (200) scans the updated PA (1702a-1702n), it performs the resynchronization with updated configuration.

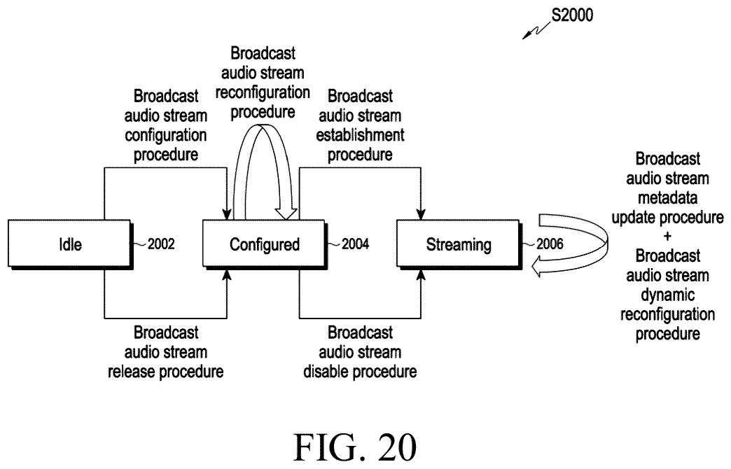

FIG. 20 is an example illustration (S2000) in which the transmitter device (100)'s state machine changes are explained, according to the embodiments as disclosed herein.

In an idle state (2002), no broadcast audio stream is being transmitted. In a configured state (2004), the transmitter device (100) has configured its codec configuration controller (440) for broadcast Audio Stream using implementation specific information or information provided by a higher layer specification. No audio data packets shall be sent in a BIG when broadcast Audio Stream state machine is in the Specified state. In a streaming state (2006), the broadcast audio stream is established on the transmitter device (100). When the PA is transmitted, the PA shall carry the BIGInfo data required to synchronize to BIGs and their BISes, and to receive broadcast audio streams. The transmitter device (100) may transmit control parameters in control packets within the BIG.

TABLE 2

| | | | | | | | |
|---|---|---|---|---|---|---|---|
| | Codec | | | | | | |
| | Capability/ | | | | | | |
| Set | Configuration | SDU_Interval | | Max_SDU | | Max_Transport_{—} | Presentation_Delay |
| Name | Settings | (μs) | Framing | (Octets) | RTN | Latency (ms) | (μs) |

Broadcast Audio Stream configuration settings for low latency audio data

| | | | | | | | |
|---|---|---|---|---|---|---|---|
| 16_2_1 | 16_2 | 10000 | unframed | 40 (32 | 1 | 10 | 40000 |
| | | | | kbps) | | | |

Broadcast Audio Stream configuration settings for high-reliability audio data(Low Quality)

| | | | | | | | |
|---|---|---|---|---|---|---|---|
| 16_2_2 | 16_2 | 10000 | unframed | 40 (32 | 4 | 60 | 40000 |
| | | | | kbps) | | | |

Broadcast Audio Stream configuration settings for high-reliability audio data(Medium Quality)

| | | | | | | | |
|---|---|---|---|---|---|---|---|
| 32_2_2 | 32_2 | 10000 | unframed | 80 (64 | 4 | 60 | 40000 |
| | | | | kbps) | | | |

Broadcast Audio Stream configuration settings for high-reliability audio data(High Quality)

| | | | | | | | |
|---|---|---|---|---|---|---|---|
| 48_2_2 | 48_2 | 10000 | unframed | 100(80 | 4 | 60 | 40000 |
| | | | | Kbps) | | | |

The Table 2 to the left shows some of broadcast Audio stream configuration settings mentioned in the Basic Audio Profile. Of these different configurations shown, 16_2_1 and 16_2_2 are mandatory for the transmitter device (100) and the receiver device (200) to support. It is the transmitter device (100)'s responsibility to communicate to the receiver device (200) which codec configuration to be used.

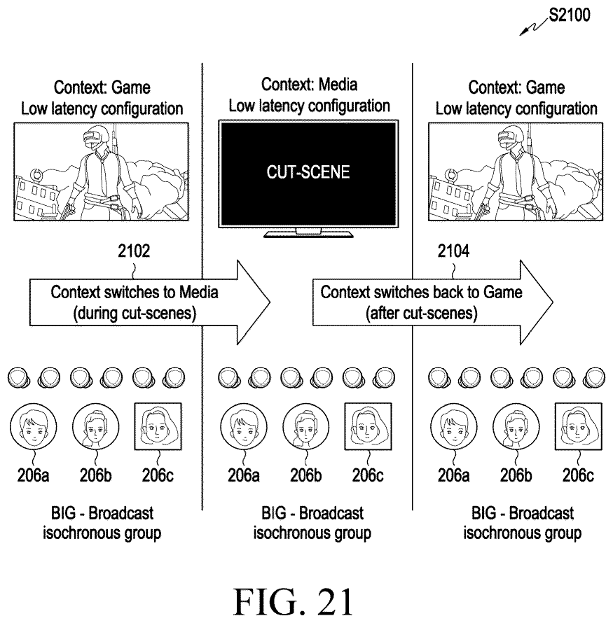

FIG. 21 is an example scenario (S2100) in which the transmitter device (100) to broadcast the audio content to the unlimited number of nearby Bluetooth audio receivers through the assistant device (300), when the transmitter device (100) detects the context switching, according to the embodiments as disclosed herein.

John (206a), Eva (206b) and Ivan (206c) are in a room, where they are surrounded by TV broadcasting audio stream over BLE. The smart TV is acting as the transmitter device (100) broadcasting audio content with stereo channels. Two BIS's are broadcasted such as left channel BIS and right channel BIS. All of them are wearing BLE audio headsets and are synchronized to the transmitter device's audio and able to listen to broadcasted audio content. Assuming, all of them are playing the game on the TV and the transmitter device (100) is broadcasting the game audio content at the low latency configuration setting. Now during playing, at 2102, the cut-scene comes in the game (i.e., the audio context switches to Media). Now as the audio context changes to media, the transmitter device (100) will detect the context change. The transmitter device (100) will send the BIG_CODEC_CONFIG_UPDATE_IND with updated codec configuration (i.e., high reliability settings) and instance when the audio content takes effect. The receiver device (200) (i.e., the BLE Audio headsets) will receive the BIG_CODEC_CONFIG_UPDATE_IND. The receiver device (200) will optimize the PA interval for faster resync, and synchronize to the updated PA. Now when the cut-scene is over, at 2104, the context will switch back to game and the above operations are will be repeated with context to provide low latency settings.

The proposed method provides the enhanced user experience such that John (206a), Eva (206b) and Ivan (206c) will be able to consume the best intended audio quality without worrying about the varying bandwidth and RF conditions. Thus results in providing the improved adaptation to content and improved and efficient use of bandwidth.

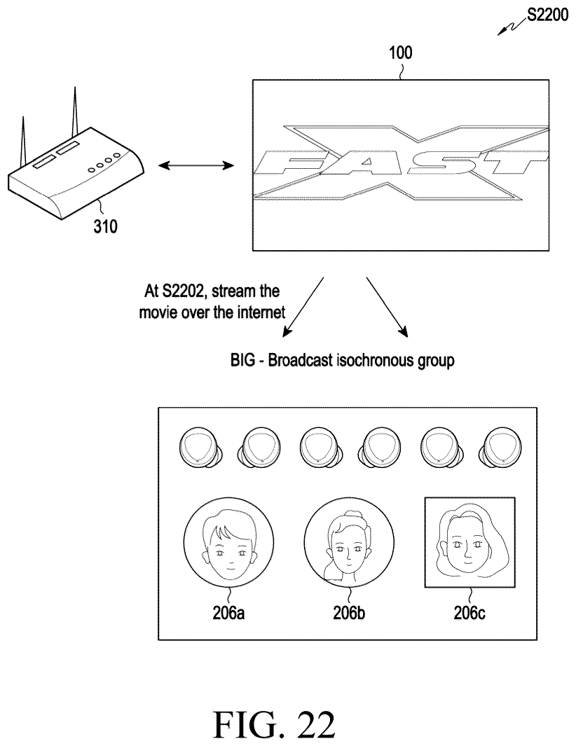

FIG. 22 is an example scenario (2200) in which the transmitter device (100) to broadcast the audio content to the unlimited number of nearby Bluetooth audio receivers when the transmitter device (100) detects bandwidth fluctuations and varying RF conditions from the Wi-Fi router (310), according to the embodiments as disclosed herein. Considers, John (206a), Eva (206b) and Ivan (206c) are in a room, where they are surrounded by TV broadcasting audio stream over BLE. The smart TV is acting as the transmitter device (100) broadcasting audio content with stereo channels. Two BIS's are broadcasted such that left channel BIS and right channel BIS. All of them are wearing BLE audio headsets and are synchronized to the transmitter device (100) audio and able to listen to broadcasted audio content. At S2202, they all decide to stream a movie over the internet. Now due to bandwidth fluctuations and varying RF conditions, the quality of the content also changes. For example: let's say the quality of the content changes from high quality to low quality. In this scenario, the transmitter device (100) will send the BIG_CODEC_CONFIG_UPDATE_IND about updated codec configuration (i.e., low quality configuration setting) and instance when it takes effect. The receiver device (200) (i.e., the BLE Audio headsets) will receive the BIG_CODEC_CONFIG_UPDATE_IND. The receiver device (200) will optimize the PA interval for faster resync, and synchronize to the updated PA.

The proposed method provides the enhanced user experience such that John (206a), Eva (206b) and Ivan (206c) will be able to consume the best intended audio quality without worrying about the varying bandwidth and RF conditions. Thus results in providing the improved adaptation to content and improved and efficient use of bandwidth.

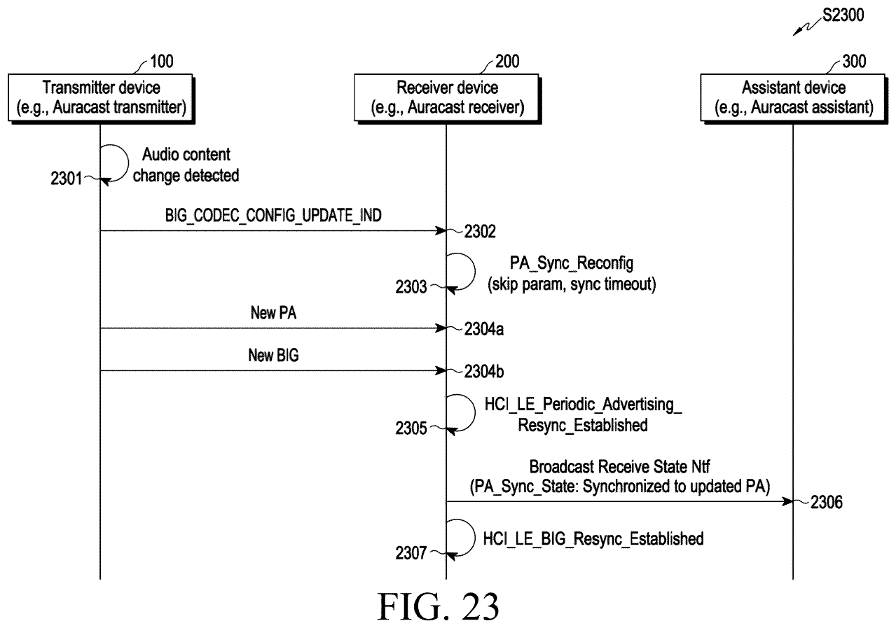

FIG. 23 illustrates example sequence diagram (S2300) in which the system manages the dynamic codec configuration of the audio stream, according to the embodiments as disclosed herein.

At operation 2301, At first, the transmitter device (100) will detect the audio content change and it will send reconfigure request to the codec configuration controller (440). At operation 2302, the codec configuration controller (440) will transmit the BIG control PDU in the control subevent of a BIG Event to indicate information about updated codec configuration and instant event. At operation 2303, the receiver device (200) will receive the BIG Control PDU and initiate PA_Sync reconfigure procedure. At operation 2304a and operation 2304b, using the skip parameter and sync timeout, the receiver device (200) will optimize the PA interval for faster resync. At operation 2305, once the receiver device (200) gets resynced to the updated PA, it will send HCI command (HCI_LE_Periodic_Advertising_Resync_Established) to indicate that it has successfully resynchronized to the updated PA of the transmitter device (100). At operation 2306, Now, the receiver device (200) will send broadcast receive state notification to the assistant device (300) with PA_sync state: Synchronized to updated PA, to inform the assistant device (300) that it has successfully resynchronized to the updated PA. At operation 2307, it will resynchronize to the BIG and send HCI command updated (HCI_LE_BIG_Resync_Established) which will indicate the same.

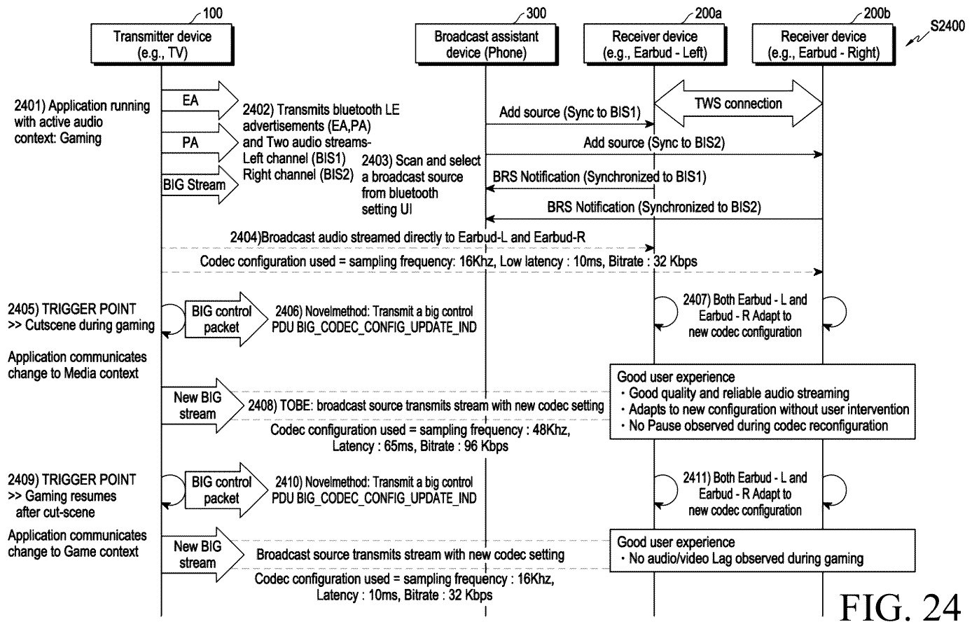

FIG. 24 is an example sequence diagram (S2400) in which the transmitter device (100) to broadcast the audio content to the unlimited number of nearby Bluetooth audio receivers through the assistant device (300) when the transmitter device (100) detects the context switching, according to the embodiments as disclosed herein.

At operation 2401, the application is running with the active audio context in the transmitter device (100). At operation 2402, the transmitter device (100) transmits the Bluetooth LE advertisements (EA,PA) and two audio streams (such as left channel(BIS1) and right Channel(BIS2)). At operation 2403, the assistant device (300) scans and selects broadcast source from the Bluetooth setting UI. The assistant device (300) adds the source to the receiver device (200a and 200b). the assistant device (300) receives the BRS notification from the receiver device (200a and 200b).

At operation 2404, the transmitter device (100) sends broadcast audio streamed directly to the receiver device (200a and 200b). At operation 2405, the transmitter device (100) detects the trigger point while receiving the cutscene during gaming. At operation 2406, the transmitter device (100) sends the BIG control packet and transmits the BIG control PDU to the receiver device (200a and 200b). At operation 2407, the receiver device (200a and 200b) adapt to new codec configuration based on the received BIG control packet.

The transmitter device (100) detects the application change from the media context from the gaming. At operation 2408, the transmitter device (100) sends the transmits stream with new codec setting to the receiver device (200a and 200b). The receiver device (200a and 200b) adapts to new configuration without user intervention based on the new codec setting. Based on the proposed method, the method may be used for good quality and reliable audio streaming.

Similarly, at operation 2409, the transmitter device (100) detects the application change from the game context from the cut scene. At operation 2410, the transmitter device (100) sends the transmit stream with new codec setting to the receiver device (200a and 200b). At operation 2411, the receiver device (200a and 200b) adapts to new configuration without user intervention based on the new codec setting. Based on the proposed method, the method may be used for good quality and reliable audio streaming.

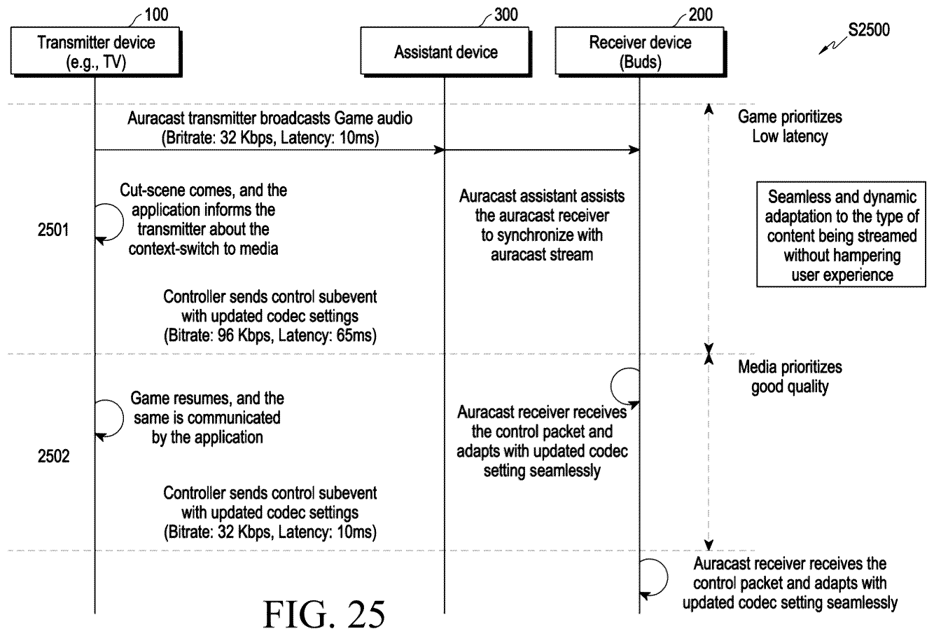

FIG. 25 is an example sequence diagram (S2500) in which the transmitter device (100) to broadcast the audio content to the unlimited number of nearby Bluetooth audio receivers when the transmitter device (100) detects bandwidth fluctuations and varying RF conditions from the Wi-Fi router, according to the embodiments as disclosed herein.

In an example, at operation 2501, the transmitter device (100) may be an transmitter device that broadcasts the game audio. Further, the transmitter device receives the cut-scene comes, and the application informs the transmitter device (100) about the context-switch to the media. The assistant device (300) assists the receiver device (200) to synchronize with stream. The controller sends control subevent with updated codec settings. The receiver device (200) updates the control subevent with updated codec settings, so that the method may be used for seamless and dynamic adaptation to the type of content being streamed without hampering user experience. At operation 2502, The transmitter device resumes the game application, and the same is communicated by the application to the receiver device (200). The controller sends control subevent with updated codec settings. The receiver device (200) receives the control packet and adapts with updated codec setting seamlessly.

The various actions, acts, blocks, operations, or the like in the flow charts (S900-S1300) may be performed in the order presented, in a different order or simultaneously. Further, in some embodiments, some of the actions, acts, blocks, operations, or the like may be omitted, added, modified, skipped, or the like without departing from the scope of the disclosure.

The foregoing description of the specific embodiments will so fully reveal the general nature of the embodiments herein that others may, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments, those skilled in the art will recognize that the embodiments herein may be practiced with modification within the scope of the embodiments as described herein.

What is claimed:

1. A method for managing codec configuration of an audio stream, comprising:
broadcasting, by a first device, the audio stream in a first codec configuration to at least one second device of a plurality of second devices;
based on the audio stream being broadcast, detecting, by the first device, an event to change the first codec configuration of the audio stream;
based on the detected event, determining, by the first device, a second codec configuration and a timing information for the audio stream, wherein the timing information indicates a time at which the second codec configuration is to be used by the at least one second device; and
based on the audio stream being broadcast, sending, by the first device to the at least one second device, a control packet comprising the second codec configuration and the timing information to modify the first codec configuration of the audio stream at the at least one second device.

2. The method of claim 1, further comprising:
sending, by the first device to the at least one second device, a broadcast isochronous group (BIG) control packet based on the second codec configuration, wherein the BIG control packet comprises an operation code field indicating a type of the control packet, and an instant field indicating a BIG event at which the second codec configuration is applied and updated codec configuration data.

3. The method of claim 1, wherein the event comprises a change in at least one of a content format indicating a quality of the audio stream, an audio context of the audio stream, and a radio frequency channel assessment indicating a congestion level of the audio stream.

4. The method of claim 1, wherein the first codec configuration of the audio stream is modified to the second codec configuration at the at least one second device without restarting broadcast of the audio stream.

5. The method of claim 1, wherein the audio stream is a low-energy audio broadcast isochronous stream.

6. A method for managing codec configuration of an audio stream, comprising:
receiving, by at least one first device of a plurality of first devices, the audio stream in a first codec configuration broadcasted by a second device;
receiving, by the at least one first device from the second device, a control packet comprising a second codec configuration and timing information, wherein the timing information of the control packet indicates a time at which the second codec configuration is to be used; and
based on receiving the audio stream broadcasted by the second device, modifying, by the at least one first device, the first codec configuration of the audio stream to the second codec configuration based on the timing information.

7. The method of claim 6, wherein the first codec configuration of the audio stream is modified to the second codec configuration at the at least one first device without restarting broadcast of the audio stream from the second device.

8. The method of claim 6, further comprising:
receiving, by the at least one first device from the second device, a broadcast isochronous group (BIG) control packet based on the second codec configuration;
updating, by the at least one first device, a skip parameter and a synchronization timeout parameter subsequent to receiving the BIG control packet from the second device; and
initiating, by the at least one first device, a reconfiguration of a periodic advertisement (PA) synchronization procedure parameters once the first codec configuration is modified to the second codec configuration, wherein the PA synchronization is performed based on the updated skip parameter and the updated synchronization timeout parameter.

9. The method of claim 8, wherein the BIG control packet comprises an operation code field indicating a type of the control packet, and an instant field indicating a BIG event at which the second codec configuration is applied and updated codec configuration data.

10. The method of claim 8, further comprising:
activating, by the at least one first device, a host controller interface (HCI) command after initiation of the reconfiguration of the PA synchronization;
broadcasting, by the at least one first device, a notification to a third device, wherein the notification represents the at least one first device is synchronized to the second codec configuration;
reconfiguring, by the at least one first device, an isochronous data path; and
receiving, by the at least one first device from the second device, a BIG control packet having the second codec configuration.

11. The method of claim 6, wherein the audio stream is a low-energy audio broadcast isochronous stream.

12. A first device for managing codec configuration of audio stream, comprising:
at least one processor including processing circuitry; and
memory storing instructions that when executed by the at least one processor individually or collectively, cause the first device to:
broadcast the audio stream in a first codec configuration to at least one second device of the plurality of second devices;
based on the audio stream being broadcast, detect an event to change the first codec configuration of the audio stream;
based on the detected event, determine a second codec configuration and a timing information for the audio stream wherein the timing information indicates a time at which the second codec configuration is to be used by the at least one second device; and
based on the audio stream being broadcasted, send a control packet to the at least one second device to modify the first codec configuration of the audio stream at the at least one second device, wherein the control packet comprises the second codec configuration and the timing information.

13. The first device of claim 12, wherein the instructions, when executed by the at least one processor individually or collectively, further cause the first device to:
sending, by the first device to the at least one second device, a broadcast isochronous group (BIG) control packet based on the second codec configuration, wherein the BIG control packet comprises an operation code field indicating a type of the control packet, and an instant field indicating a BIG event at which the second codec configuration is applied and updated codec configuration data.

14. The first device of claim 12, wherein the event comprises a change in at least one of a content format indicating a quality of the audio stream, an audio context of the audio stream, and a radio frequency channel assessment indicating a congestion level of the audio stream.

15. The first device of claim 12, wherein the first codec configuration of the audio stream is modified to the second codec configuration at the at least one second device without restarting broadcast of the audio stream.

16. The first device of claim 12, wherein the audio stream is a low-energy audio broadcast isochronous stream.
